(19) United States
(12) Patent Application Publication
(10) Pub. No.: US 2012/0089335 A1
(43) Pub. Date: Apr. 12, 2012

(54) FLUID PRESSURE-VISCOSITY ANALYZER FOR DOWNHOLE FLUID SAMPLING PRESSURE DROP RATE SETTING

(75) Inventors: Sunil Kumar, Celle (DE); Sebastian Csutak, Houston, TX (US); Paul A. Bergren, Houston, TX (US); Rocco Difoggio, Houston, TX (US)

(73) Assignee: BAKER HUGHES INCORPORATED, Houston, TX (US)

(21) Appl. No.: 13/269,999

(22) Filed: Oct. 10, 2011

Related U.S. Application Data
(60) Provisional application No. 61/391,831, filed on Oct. 11, 2010.

(51) Int. Cl. E21B 49/08; E21B 47/00; G06F 19/00

(52) U.S. Cl. 702/6; 73/152.18; 73/152.23

(57) ABSTRACT

Methods and apparatus for estimating a hydrocarbon fluid parameter using a hydrocarbon fluid testing module. The method may include estimating a hydrocarbon fluid parameter value where a precipitate begins to form in a hydrocarbon fluid sample. The method may also include extracting a hydrocarbon fluid sample under pre-precipitate conditions; changing at least one hydrocarbon fluid parameter, generating information indicative of precipitate formation; and communicating the estimated value of the hydrocarbon fluid parameter at the precipitate formation point. The method may also include producing hydrocarbon fluid sample from a formation using the estimated value and a bubble point. The disclosure also includes an apparatus for implementing the method.

### CROSS-REFERENCES TO RELATED APPLICATIONS

This application claims priority from U.S. Provisional Patent Application Ser. No. 61/391,831, filed on 11 Oct. 2010, the disclosure of which is incorporated herein by reference in its entirety.

### FIELD OF THE DISCLOSURE

This disclosure generally relates to the production of hydrocarbons involving analysis of fluids in or from an earth formation. More specifically, this disclosure relates to estimating the environmental conditions for precipitate to form in a hydrocarbon fluid.

### BACKGROUND OF THE DISCLOSURE

Fluid evaluation techniques are well known. Broadly speaking, analysis of fluids may provide valuable data indicative of formation and wellbore parameters. Many fluids (such as formation fluids, production fluids, and drilling fluids) contain a large number of components with a complex composition. Fluids may contain oil and/or water insoluble compounds, such as clay, silica, waxes, and asphaltenes, which exist as colloidal suspensions. Fluids may also contain inorganic components. The complex composition of fluids may be sensitive to changes in the environment, including movement of the fluid from one pressure to another or travel up a drill pipe. Changes in the environment may cause unwanted precipitation, which may affect the permeability of a subterranean formation. Formation damage can occur due to the deposition of paraffins, asphaltenes, and resins which may be mixed with some inorganic matters such as clays, sand and other debris. The deposits form scales which could be either natural or induced. The paraffin deposition primarily occurs by temperature decrease, whereas the most probable cause of asphaltene deposition (Leontaritis et al. 1992) are (1) drop in the reservoir pressure below the pressure at which asphaltenes flocculate and begin to drop out; (2) mixing of solvents, CH₄, CO₂ with reservoir oil during End-Of-Run (EOR) and the intrinsic positive charge on asphaltenes that attach to negatively charged surface, such as clays and sand. Wax deposition is rather limited to near wellbore region and occurs by the cooling of the oil caused either by high perforation pressure losses during oil production or by invasion and cooling of the hot oil saturated with the wax dissolved from the well walls as a result of the overbalanced, hot oiling treatments of the wells.

During production operations, a well may be operated at pressures that may maximize the fluid flow out of the formation. Formation fluid flow rates tend to increase as pressure decreases because viscosity may decrease with pressure until the pressure reaches the “bubble point” for the fluid. When fluid pressure decreases below the bubble point, the viscosity of the fluid may increase as pressure continues to decrease, resulting in decreased fluid flow. If the pressure drops low enough, precipitates, such as asphaltenes and waxes, may drop out of the fluid and begin to clog the pores of the formation. If the pores are clogged, the permeability of the formation may be irreversibly damaged. Once precipitates begin to drop out of the fluid, the precipitates may quickly flocculate or agglomerate. In certain aspects, this disclosure provides an apparatus and method for estimating the environmental conditions for precipitate drop out in a hydrocarbon fluid

### SUMMARY OF THE DISCLOSURE

In aspects, this disclosure generally relates to the production of hydrocarbons involving analysis of fluids in or from an earth formation. More specifically, this disclosure relates to estimating the environmental conditions for precipitate to form in a hydrocarbon fluid.

One embodiment according to the present disclosure may include a method of estimating a parameter of a hydrocarbon fluid sample, comprising: estimating the hydrocarbon fluid parameter using information from at least one sensor while causing a precipitate to form in a hydrocarbon fluid sample.

Another embodiment according to the present disclosure may include an apparatus for estimating a parameter of a hydrocarbon fluid sample, comprising: at least one test cell configured to receive the hydrocarbon fluid sample, the at least one test cell including at least one regulator; at least one sensor configured to generate information indicative of precipitate formation in the hydrocarbon fluid; and at least one processor configured to estimate the parameter of the hydrocarbon fluid sample based on the information.

Examples of certain features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a hydrocarbon fluid testing module deployed in a wellbore along a wireline according to one embodiment of the present disclosure;

FIG. 2 shows a schematic of an exemplary hydrocarbon fluid testing module according to one embodiment of the present disclosure;

FIG. 3 shows a flow chart of an exemplary method for estimating a hydrocarbon fluid parameter using a hydrocarbon fluid testing module for parallel evaluation of a divided hydrocarbon fluid sample according to one embodiment of the present disclosure;

FIG. 4 shows a flow chart of an exemplary method for estimating a hydrocarbon fluid parameter using a hydrocarbon fluid testing module for sequentially evaluating a hydrocarbon fluid sample according to one embodiment of the present disclosure; and

FIG. 5 graphically illustrates the relationship between the precipitate pressure point and the bubble point of a hydrocarbon fluid in terms of viscosity and formation pressure.

### DETAILED DESCRIPTION

This disclosure generally relates to the production of hydrocarbons involving analysis of fluids in or from an earth formation. More specifically, this disclosure relates to estimating the fluid parameters for precipitate to form in a hydrocarbon fluid. In one aspect, the present disclosure relates to a method for estimating a precipitate drop out point for a hydrocarbon fluid. The production rate for a hydrocarbon fluid from a formation may be limited or restricted by the viscosity of the hydrocarbon fluid. Over a range of fluid parameters, the viscosity of a hydrocarbon fluid may vary. These fluid parameters may include, but are not limited to, one or more of: (i) pressure, (ii) temperature, (iii) flow rate, and (iv) amount of additive.

For example, the flow rate of fluid out of a formation may be modeled by the formula:

$$q = \frac{κ}{η} Δ p ,$$

where q is the flow rate, κ is the permeability of the formation, η is the viscosity of the formula, and Δp is the pressure difference between the formation and the borehole. Thus, it may be observed that flow rate may vary inversely with viscosity and proportionally with formation permeability. The effective mobility of oil, which is a convenient measure of the oil flow capability, may be expressed as:

$$λ = \frac{κ}{η} {k}_{r 0} ,$$

where kᵣₒ is the relative permeability of oil.

Viscosity of the hydrocarbon, and with it the flow rate, may vary with changes in pressure and temperature or by the addition of additives. However, if the pressure of the hydrocarbon fluid decreases too much, some components of the hydrocarbon fluid may begin to drop out. Herein, the precipitate drop out point is the value of a fluid parameter where at least one component of the fluid, or “precipitate,” begins to drop out of the hydrocarbon fluid. For example, if the fluid parameter is pressure and the first precipitate is an asphaltene, then the precipitate drop out point would be the pressure value when the first asphaltene drops out of the hydrocarbon fluid. Herein, “dropping out” of a hydrocarbon fluid includes flocculation and sedimentation such that a component may have dropped out but part of it may still remain entrained in or suspended in the hydrocarbon fluid.

Since a change in fluid parameters may trigger the drop out of a precipitate, one embodiment according to the present disclosure includes a method with a step for extracting a sample from the formation at a temperature, pressure, and flow rate that are below the threshold where a precipitate would be formed. Once the sample is extracted, the fluid parameters may be varied to induce precipitation. The method may include using at least one sensor that estimates the presence of a precipitate in the hydrocarbon fluid. The precipitate sensor may be configured to be responsive to, but is not limited to, one or more of: (i) refractive index, (ii) mechanical force, (iii) density, (iv) viscosity, (v) electrical conductivity, and (vi) chemical composition. The method may also include using at least one sensor to estimate at least one fluid parameter, where the at least one sensor is configured to generate information indicative of the at least one fluid parameter. Herein, “information” may include raw data, processed data, analog signals, and digital signals.

Another aspect of the present disclosure may include using the information in operations to regulate the production of the hydrocarbon fluid. For example, the information may be indicative of the pressure value where asphaltenes begin to drop out of the hydrocarbon fluid, and this information may be combined with the bubble point of the hydrocarbon fluid in a model to estimate an operating pressure that enhances the flow rate of hydrocarbon fluid out of the formation while reducing the possibility that the operating pressure may be set to a value that may damage the permeability of the formation. While maintaining operating pressures above the bubble point may be common in the production industry, the present disclosure provides methods for operating between the drop out pressure point and the bubble point. In another embodiment, the information may be used to improve the hydrocarbon fluid flow rate while preventing damage to the pores. In another embodiment, the method may be used at the surface to establish parameters for future samples of hydrocarbon fluids from the formation. Some embodiments according to the present disclosure may be used on the surface, downhole, or both.

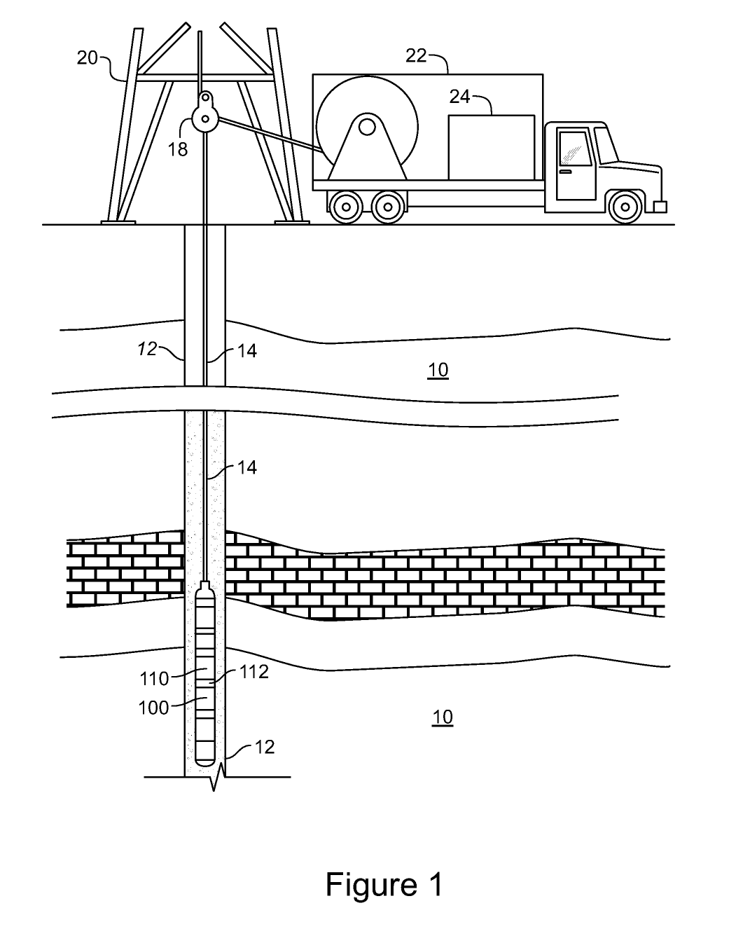

Referring initially to FIG. 1, there is schematically represented a cross-section of a subterranean formation 10 in which is drilled a borehole 12. Suspended within the borehole 12 at the bottom end of a conveyance device such as a wireline 14 is a downhole assembly 100. The wireline 14 is often carried over a pulley 18 supported by a derrick 20. Wireline deployment and retrieval is performed by a powered winch carried by a service truck 22, for example. A control panel 24 interconnected to the downhole assembly 100 through the wireline 14 by conventional means controls transmission of electrical power, data/command signals, and also provides control over operation of the components in the downhole assembly 100. The data may be transmitted in analog or digital form. Downhole assembly 100 may include a fluid testing module 112. Downhole assembly 100 may also include a sampling device 110. Herein, the downhole assembly 100 may be used in a drilling system (not shown) as well as a wireline. While a wireline conveyance system has been shown, it should be understood that embodiments of the present disclosure may be utilized in connection with tools conveyed via rigid carriers (e.g., jointed tubular or coiled tubing) as well as non-rigid carriers (e.g., wireline, slickline, e-line, etc.). Some embodiments of the present disclosure may be deployed along with Logging While Drilling/Measurement While Drilling (LWD/MWD) tools.

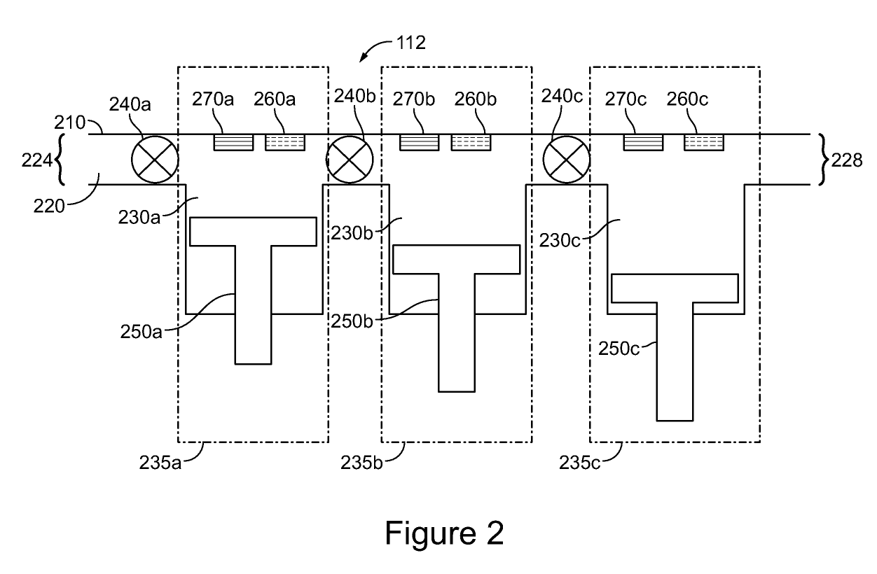

FIG. 2 shows an exemplary embodiment according to the present disclosure. The hydrocarbon fluid testing module 112 may be formed from a housing 210, such as a tubular or pipe, configured to receive a sample of a hydrocarbon fluid 220. Hydrocarbon fluid sample 220 may include, but is not limited to, one or more of: (i) drilling hydrocarbon fluid, (ii) formation hydrocarbon fluid, and (iii) fracturing hydrocarbon fluid. Hydrocarbon fluid 220 may enter the housing 210 through inlet 224 (upstream) and exit through outlet 228 (downstream). In some embodiments, the inlet 224 and outlet 228 may be reversible. The hydrocarbon fluid sample 220 may be divided into one or more test cells 235a-c, which may be isolated from one another by valves 240a-c. Each test cell 235a-c may include a volume 230a-c and a pressure regulator (such as a piston) 250a-c configured to change the size of the volume 230a-c. The pressure regulator 250a-c may include a spring mounted piston with an electromagnetic clutch configured to withstand downhole environmental conditions, including vibration, shock, temperature, and pressure. The use of piston as a pressure regulator is exemplary and illustrative only, as other pressure regulator devices may be used.

In some embodiments, a chemical pump (not shown), such as a getter pump, may be used to regulate the pressure in the test cells 235a-c. The chemical pump may include a high temperature “getter” material configured to absorb or chemically combine with gases. The getter material may chemically combine with a gas to remove the gas from a portion of the test cell isolated from the remainder of the test cell by a membrane, where the remainder of the test cell may include the hydrocarbon fluid 220. The act of the gas combining with the getter material may create a vacuum in the isolated portion of a test cell, and the creation of the vacuum may move the membrane, resulting in a change of volume (and thus pressure) within the remainder of the test cell. In still other embodiments, pressure regulation may be provided by a membrane pump (not shown), as a membrane pump may be well suited for use in high vibration environments. The use of pistons, chemical pumps, and membrane pumps as pressure regulators are exemplary and illustrative only, as other pressure regulators may be used as would be understood by one of skill in the art.

The presence of three test cells in the hydrocarbon fluid testing module is exemplary and illustrative only, as a greater or lesser number of test cells may be present. In some embodiments, one or more of the test cells may not have a pressure regulator 250a-c. As the size of the volume 230a-c increases, the pressure within the volume 230a-c may decrease. In some embodiments, one or more test cells 235a-c may include one or more temperature regulators 260a-c to adjust the temperature parameter of the volumes 230a-c of hydrocarbon fluid sample 220. The temperature regulators 260a-c may include at least one of: (i) a heating element and (ii) a cooling element. In some embodiments, heating may be provided by using a thin-film sputtered heater. The thin-film sputtered heater may be disposed a wall of the test cell 235a-c. In some embodiments, a thin-film sputtered heater may be configured to provide uniform heating the fluid sample 220 within the test cell 235a-c. In some embodiments, cooling may be provided by using a Peltier cooler. The use of thin-film sputtered heaters and Peltier coolers as temperature regulators are exemplary and illustrative only, as other temperature regulators may be used as would be understood by one of skill in the art. Sensor array 270a-c may be positioned within each test cell 235a-c to estimate at least one hydrocarbon fluid parameter and detect the formation of a precipitate. The sensor array 270a-c may include, but is not limited to, one or more of: (i) an optical sensor, (ii) a mass sensor, (iii) a viscometer, (iv) a sound speed sensor, (v) an electrical conductivity sensor, (vi) a chemical sensor. In one embodiment, the chemical sensor may include a thin-film semiconductor configured to detect specific chemical compositions, such as H₂S. The thin-film semiconductor chemical sensor may be configured to detect at least one selected chemical without using a membrane to detect the gas phase of the selected chemical. In some embodiments, the chemical sensor may include a semiconductor comprised of, but not limited to, one or more of: WO₃, CuO—SnO₂, and SnO₂. The use of a thin-film semiconductor chemical sensor in the sensor array is exemplary and illustrative only, as other types of sensors may be used as would be understood by one of skill in the art. In some embodiments, the sensor arrays may be divided into two or more separate sensors at different locations. In some embodiments, the sensor array may be configured to detect precipitate formation while the hydrocarbon fluid parameter is indirectly estimated. For example, in one embodiment, the sensor array may detect the formation of precipitate and the pressure in the volume may be estimated based on piston position rather than information from a pressure sensor.

After a test has been performed, the hydrocarbon fluid sample 220 may flow out of the fluid testing module 112 through outlet 228. In some embodiments, sensor array 270a-c may be configured for use in estimating at least one of: (i) absolute viscosity of the hydrocarbon fluid sample 220 and (ii) relative viscosity of the hydrocarbon fluid sample 220. In some embodiments, the fluid testing module 112 may include a cleaning device (not shown) to remove precipitate or residual hydrocarbon fluid from the fluid testing module 112. The cleaning device may include, but is not limited to, one or more of: (i) a buffer solution jet, (ii) a cleaning fluid jet, (iii) an acoustic cleaner, and (iv) a vibration cleaner.

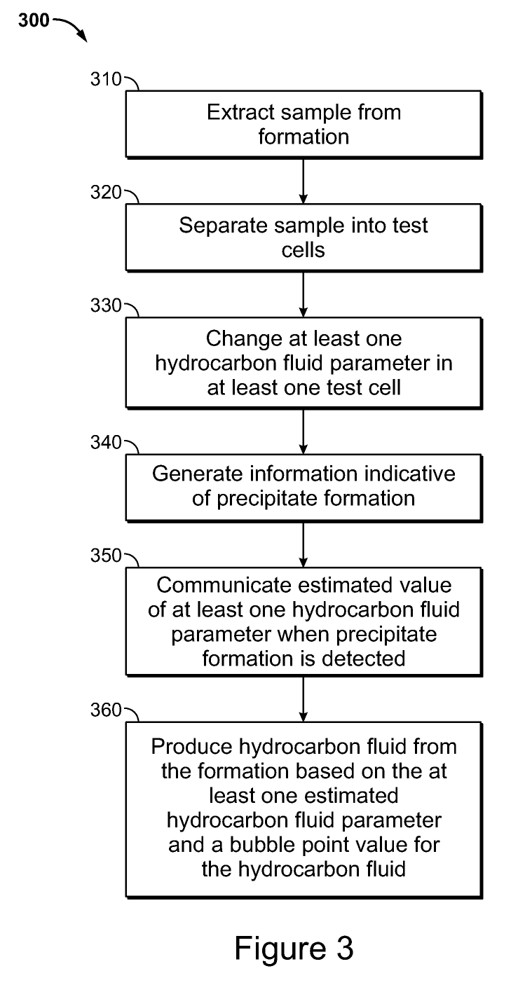

FIG. 3 shows an exemplary method 300 according to one embodiment of the present disclosure. In step 310, a hydrocarbon fluid sample 220 may be extracted from formation 10 under conditions where the hydrocarbon fluid parameters will not cause precipitate to form or drop out of the hydrocarbon fluid sample 220. In step 320, the sample 220 may be divided into multiple test cells 235a-c in hydrocarbon fluid testing module 112. Each test cell 235a-c may contain a pressure regulator 250a-c, at least one sensor array 270a-c, at least one temperature regulator 260a-c, and a volume 230a-c, which may be defined by the housing 210. In step 330, at least one hydrocarbon fluid parameter may be changed in one or more of the volumes 230a-c. The hydrocarbon fluid parameters may be changed using one or more of the heaters 260a-c, pistons 250a-c, or valves 240a-c. In some embodiments, a combination of fluid parameters may be changed simultaneously. In some embodiments, step 330 may include adding an amount of an additive to one or more volumes 230a-c. The hydrocarbon fluid parameters may continue to change until a precipitate is detected or until the fluid parameters have been adjusted across a desired range. In step 340, information indicative of the formation of a precipitate may be generated by at least one sensor array 270a-c. In step 350, the at least one sensor array 270a-c may communicate information indicative of at least one value of the at least one hydrocarbon fluid parameter when the precipitate is detected by one of the sensor arrays 270a-c. For example, once the precipitate is detected in volume 230b, the sensor array 270b may send information regarding the pressure value for volume 230b. Steps 320-350 may be performed downhole, at the surface, or divided between downhole and the surface. In step 360, the information indicative of the hydrocarbon fluid parameter may be used in the production of hydrocarbon fluid alone or in combination with additional information regarding the hydrocarbon fluid. For example, the pressure value where precipitate first forms may be used with the bubble point of the hydrocarbon fluid to generate a pressure operation band or range for hydrocarbon fluid production. The viscosity change of the hydrocarbon fluid sample 220 under varying pressure, temperature, and shear rates—with the pressure and temperature values defining the deposition points of wax, asphaltenes and resin—may be used to generate a deposition envelope of the specific crude and reservoir combination that may give operators a deposition envelope that operators may use to set a thermodynamic path for production which is outside of the deposition envelope. The deposition envelope may be defined using one or more estimates of environmental conditions where a precipitate may drop out of the hydrocarbon fluid. For example, the deposition envelope may be a range of pressure-related values.

Operating outside the deposition envelope may allow operators to improve or maintain productivity of wells. The decline of productivity of wells in asphaltenic reservoirs is usually attributed to the reduction of the effective mobility of oil by various factors (Amaefule et al., 1988; Leontaristis et al., 1992, 1998). The three mechanisms (Leontaritis, 1998) that are used for explaining the asphaltene-induced damage are (1) increases in reservoir fluid viscosity by formation of water-in-oil emulsion if the well is producing oil and water simultaneously, (2) changes of wettability of the reservoir formation from water-wet to oil-wet by the adsorption of asphaltene over the pore surface of the reservoir, and (3) impairment of the reservoir formation permeability by plugging of the pore throats by asphaltene particles. The problem associated with organic deposition from crude oil can be avoided or minimized by choosing operating conditions such that the reservoir oil follows a thermodynamic path outside the deposition envelope.

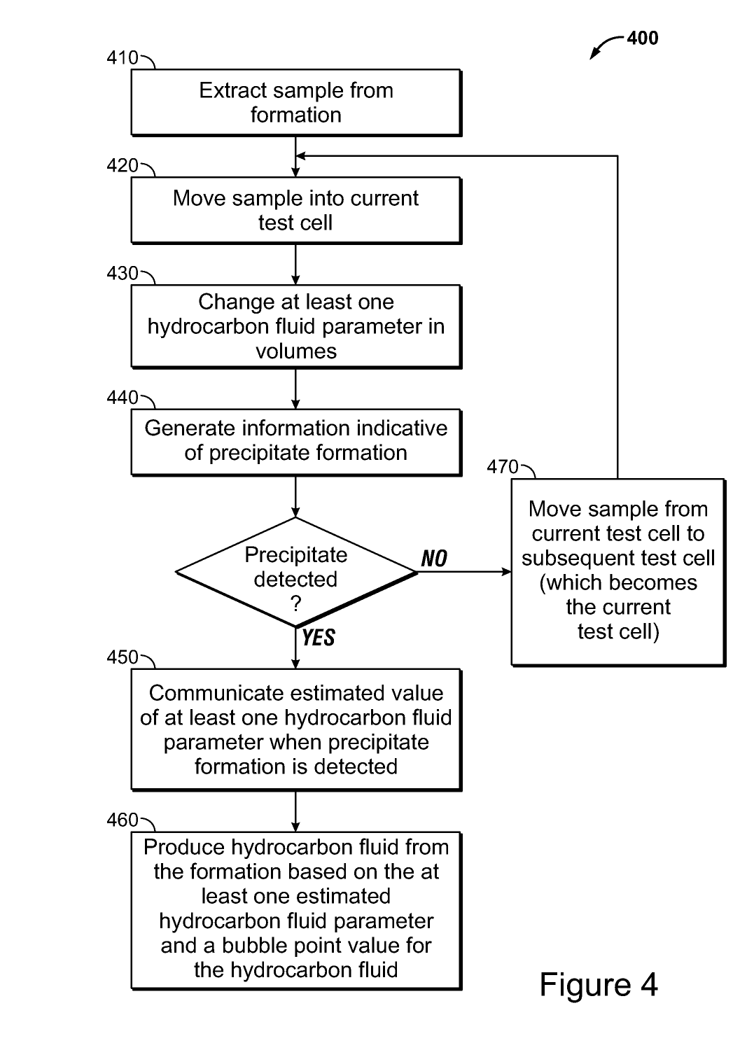

FIG. 4 shows an exemplary method 400 according to one embodiment of the present disclosure. In step 410, a hydrocarbon fluid sample 220 may be extracted from formation 10 under conditions where the hydrocarbon fluid parameters will not cause precipitate to form or drop out of the hydrocarbon fluid sample 220. In step 420, the sample 220 may be moved into test cell 235a of hydrocarbon fluid testing module 112 and isolated by one more valves 240a-c. In step 430, at least one hydrocarbon fluid parameter may be changed in volume 230a. The hydrocarbon fluid parameters may be changed using one or more of the heaters 260a, piston 250a, or valves 240a. In some embodiments, a combination of fluid parameters may be changed simultaneously. In some embodiments, step 430 may include adding an additive to volume 230a. The hydrocarbon fluid parameters may continue to change until a precipitate is detected or until the fluid parameters have been adjusted across a desired range. In step 440, information indicative of the formation of a precipitate may be generated by at least one sensor array 270a. In some embodiments, sensor array 270a may be configured to estimate at least one of: (i) absolute viscosity of the hydrocarbon fluid sample 220 and (ii) relative viscosity of the hydrocarbon fluid sample 220. If the precipitate has been detected then, in step 450, the at least one sensor array 270a may communicate information indicative of at least one value of the at least one hydrocarbon fluid parameter when the precipitate is detected by one of the sensor arrays 270a. If the precipitate has not been detected, then, in step 470, hydrocarbon fluid sample 220 may be moved from a current test cell to a subsequent test cell—in this instance, test cell 235a to test cell 235b by opening valve 240b. The movement of sample 220 may be performed by mechanical force, pumping, acoustic vibration, or other fluid transport systems known to those of skill in the art (not shown). After step 470, the method may jump back to step 420 and proceeds using the subsequent test cell that is now the current test cell. This process may continue until a designated stopping point, the detection of precipitate, or the hydrocarbon fluid testing module 112 exhausts its complement of test cells 235a-c. Steps 420-450 may be performed downhole, at the surface, or divided between downhole and the surface. In step 460, the information indicative of the hydrocarbon fluid parameter may be used in the production of hydrocarbon fluid alone or in combination with additional information regarding the hydrocarbon fluid and/or the reservoir. For example, the pressure value where precipitate first forms may be used with the bubble point of the hydrocarbon fluid to generate a pressure operations band or range for hydrocarbon fluid production.

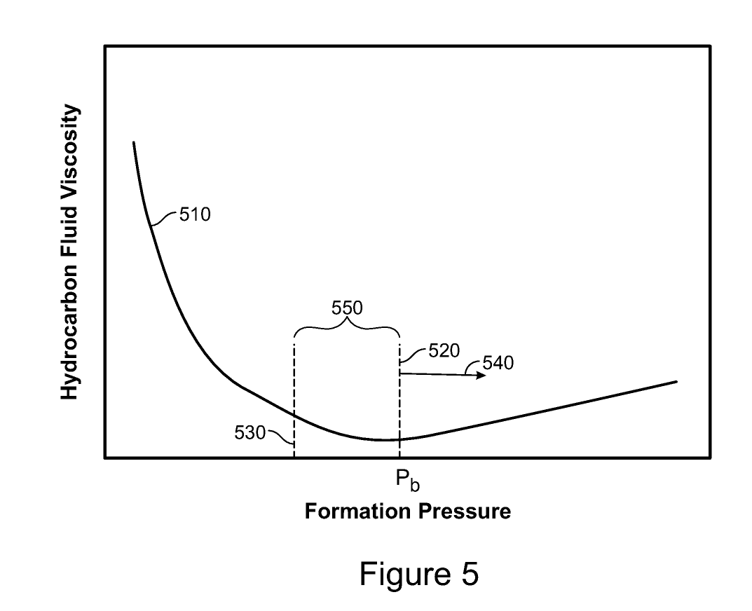

FIG. 5 shows a graphical illustration of the precipitate point in hydrocarbon fluid production. 510 is a curve representing the viscosity of a hydrocarbon fluid over a range of formation pressures, P_{b}. 520 is the pressure of the bubble point of the hydrocarbon fluid. 530 represents the pressure where the first precipitate forms in the hydrocarbon fluid. An arrow 540 indicates the hydrocarbon fluid production pressure operating range for the formation when operating pressure is kept above the bubble point. A bracket 550 indicates the hydrocarbon fluid production pressure operating range between the precipitate point and the bubble point, such that operations may continue without risk of damage to the permeability of the formation due to precipitates forming.

While the foregoing disclosure is directed to the one mode embodiments of the disclosure, various modifications will be apparent to those skilled in the art. It is intended that all variations be embraced by the foregoing disclosure.

What is claimed is:

1. A method of estimating a parameter of a hydrocarbon fluid sample, comprising:
estimating the hydrocarbon fluid parameter using information from at least one sensor while causing a precipitate to form in a hydrocarbon fluid sample.

2. The method of claim 1, further comprising:
estimating a deposition envelope using the estimated hydrocarbon fluid parameter.

3. The method of claim 1, further comprising:
estimating an operating pressure band using the estimated hydrocarbon fluid parameter.

4. The method of claim 1, further comprising:
decreasing the pressure of the hydrocarbon fluid sample until the precipitate begins to form in the hydrocarbon fluid sample.

5. The method of claim 1, further comprising:
changing the hydrocarbon fluid parameter until the precipitate begins to form in the hydrocarbon fluid, the hydrocarbon fluid parameter being selected from the group consisting of: (i) temperature and (ii) an amount of additive in the hydrocarbon fluid sample.

6. The method of claim 1, further comprising:
adding a nonpolar solvent to the hydrocarbon fluid sample until the precipitate begins to form in the hydrocarbon fluid sample.

7. The method of claim 6, wherein the nonpolar solvent includes at least one of: (i) pentane, (ii) hexane, and (iii) heptane.

8. The method of claim 1, wherein the precipitate comprises at least one asphaltene.

9. The method of claim 1, further comprising:
recovering the hydrocarbon fluid sample using a sampling device configured to be conveyed in a wellbore.

10. The method of claim 1, further comprising:
producing the hydrocarbon fluid sample at a production pressure value estimated based on the estimated hydrocarbon fluid parameter value.

11. The method of claim 1, further comprising:
producing the hydrocarbon fluid sample at a production parameter value estimated based the estimated hydrocarbon fluid parameter value.

12. The method of claim 11, wherein the production parameter is selected from the group consisting of: (i) flow rate, (ii) pressure, (iii) temperature, and (iv) an amount of chemical additive in the hydrocarbon sample.

13. The method of claim 1, wherein the hydrocarbon fluid sample includes at least one of: (i) drilling hydrocarbon fluid, (ii) formation hydrocarbon fluid, and (iii) fracturing hydrocarbon fluid.

14. An apparatus for estimating a parameter of a hydrocarbon fluid sample, comprising:
at least one test cell configured to receive the hydrocarbon fluid sample, the at least one test cell including at least one regulator;
at least one sensor configured to generate information indicative of precipitate formation in the hydrocarbon fluid; and
at least one processor configured to estimate the parameter of the hydrocarbon fluid sample based on the information.

15. The apparatus of claim 14, wherein at least one regulator includes at least one of: (i) a temperature regulator, (ii) a pressure regulator, and (iii) an additive regulator.

16. The apparatus of claim 15, wherein the temperature regulator includes at least one of: (i) a thin-film sputtered heater and (ii) a Peltier cooler.

17. The apparatus of claim 15, wherein the pressure regulator includes at least one of: (i) a piston, (ii) a chemical pump, (iii) a getter pump and (iv) a membrane pump.

18. The apparatus of claim 15, wherein the additive regulator includes an additive pump and an additive supply.

19. The apparatus of claim 18, wherein the additive supply includes a nonpolar solvent.

20. The apparatus of claim 14, wherein the at least one sensor is configured to estimate at least one of: (i) refractive index, (ii) weight, (iii) density, (iv) viscosity, (v) conductivity, and (vi) chemical composition.
